(19) United States
(12) Patent Application Publication
(10) Pub. No.: US 2009/0015583 A1
(43) Pub. Date: Jan. 15, 2009

(54) DIGITAL MUSIC INPUT RENDERING FOR GRAPHICAL PRESENTATIONS

(75) Inventors: Harvey W. Starr, San Diego, CA (US); Timothy M. Doyle, San Diego, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Starr Labs, Inc., San Diego, CA (US)

(21) Appl. No.: 12/106,100

(22) Filed: Apr. 18, 2008

Related U.S. Application Data
(60) Provisional application No. 60/912,654, filed on Apr. 18, 2007.

(51) Int. Cl. G06T 15/00; G06F 3/048

(52) U.S. Cl. 345/419; 715/849

(57) ABSTRACT

A graphical presentation is produced at a display of a host computer such that a scene description is rendered and updated by a received digital music input, wherein the digital music input is matched to trigger events of the scene description and actions of each matched trigger event are executed in accordance with action processes of the scene description, thereby updating the scene description with respect to objects depicted in the scene on which the actions are executed. The updated scene description is then rendered. The system provides a means for connecting a graphics API to a musical instrument digital interface (e.g., MIDI) data stream and producing a presentation.

This application claims the benefit of U.S. Provisional Patent Application Ser. No. 60/912,654 entitled “Digital Music Input Rendering For Graphical Presentations” by Harvey W. Starr et al., filed Apr. 18, 2007. Priority of the filing date is hereby claimed, and the disclosure of the application is hereby incorporated by reference.

### BACKGROUND

A variety of computer software programs are available for defining and manipulating objects in a virtual three-dimensional (3D) world. For example, “3DSMax” from Autodesk, Inc. and Solidworks are available. They provide an assortment of tools in a convenient graphical user interface (GUI) for manipulation and editing of 3D virtual objects. Programs for computer display screensavers also permit manipulation of moving images.

Also having great popularity are computer software programs for manipulation of video clips, multimedia clips, and the like. Such programs include Max, Aperture, and ArKaos.

Another popular medium that supports creativity with computers are the various computer software applications that involve the musical instrument digital interface (MIDI) standard. The MIDI standard permits connection of musical instruments with digital output to related digital sound processing devices, including computers with sound cards and sound editing applications, sound boards, broadcast equipment, and the like.

Music has become commonly performed with instruments that send digital MIDI data since the introduction of MIDI in approximately 1985. MIDI provides a flexible set of instructions that are sent via a serial data link from a controller to a receiver that processes those commands in a variety of ways that pertain to the output functions of the receiving device. The data and instructions involve most commonly that of sounds and music, but can also involve instructions for machine control and lighting control devices.

A separate branch of technology is the development of computer video graphics, the digital electronic representation and manipulation of virtual worlds comprised of three dimensional objects in a 3D space with applications in many fields, from microscopic imaging to galactic modeling and notably computer graphics for films and gaming environments.

There have been a few attempts to associate the direct performance of music with computer video and graphics in an effort to create new art forms. One program, Bliss Paint for the Macintosh, used MIDI input to change colors on an evolving rendering of a fractal image. Another program, ArKaos, uses MIDI commands to play video clips in a DJ-like process other program, MaxMSP, uses MIDI commands in flexible environment to drive video clips, audio clips, and drive external events.

There are many computer programs that control sound in various ways in response to a MIDI command stream. The “3DMIDI” program appears to be un-supported and it is not clear if the software works or ever worked. The available documentation describes set of separate programs that each performs a prescribed set of transformations to an embedded set of objects in response to MIDI. Each different performance is loaded and executed separately, and has its own unique tool set to make specific adjustments particular to the objects in that scene. There is an API shown that invites others to develop their own performances, each with their own unique sets of objects and tools which can not be edited at that point.

Unfortunately, there is no convenient user interface available for interacting computer graphics with musical instrument digital data. Conventional methods generally require cumbersome specification of input sources, scene description parameters and data objects, and linking of input sources and scene description objects. As a result, a relatively high level of computer skills are necessary for creating graphical presentations in conjunction with music input. It would be improve creative output if users could create scenes with objects and change both the objects and the nature of the interaction between the video graphics and MIDI music data.

As a result of these difficulties and increased complexity, there is need for a graphical user interface that supports integration with digital musical instruments. The present invention satisfies this need.

### SUMMARY

In accordance with embodiments of the invention, a graphical presentation is produced at a display of a host computer such that a scene description is rendered and updated by a received digital music input, wherein the digital music input is matched to trigger events of the scene description and action of each matched trigger event are executed in accordance with action processes of the scene description, thereby updating the scene description with respect to objects depicted in the scene on which the actions are executed. The updated scene description is then rendered. Thus, the invention provides a means for connecting a graphics API to a musical instrument digital interface (e.g., MIDI) data stream and producing a presentation. In this way, digital musical instruments can be integrated with graphical presentation techniques for an entertaining user experience.

In one embodiment, a computer system includes two active display windows, an Editor Application window and a Render (display) window. The Editor Application can be used for generation of scene descriptions with user input panels for defining parameters relating to six characteristics of the scene description: Triggers, Actions, Objects, Links, Splines, and Play control. A wide variety of playback and scene description controls are provided for user specification through the Editor Application. The scene description itself can be edited to specify scenes parameters such as groups and of combinations of triggers and scene objects and actions, as well as linkages and play control. The triggers can comprise selected MIDI commands, and the actions can comprise transformations performed on scene objects. The objects themselves can be defined in imported scene descriptions, including 3D graphics files, which may be rendered on the computer screen. The scene description can also include spline nodes that define an animation path. The Render window displays the results of the rendering operation to show the scene description file as processed with digital musical input.

Other features and advantages of the present invention should be apparent from the following description of the preferred embodiment, which illustrates, by way of example, the principles of the invention.

### BRIEF DESCRIPTION OF THE DRAWINGS

FIG. 1 is a flow diagram that illustrates processing operations performed by a computer system constructed in accordance with the invention.

FIG. 2 is a flow diagram that illustrates processing operations performed by a computer system constructed in accordance with the invention for processing user inputs.

FIG. 3 is a flow diagram that illustrates processing operations performed by a computer system constructed in accordance with the invention for processing trigger events.

FIG. 4 shows a host computer display with a playback window and an editor window.

FIG. 5 is a detail view of the Scene tab panel of the editor application window from FIG. 4.

FIG. 6 shows details of the Trigger panel of the editor application window from FIG. 4.

FIG. 7 shows the Action panel of the editor application window from FIG. 4.

FIG. 8 shows the Object panel of the editor application window from FIG. 4.

FIG. 9 shows the Links panel 900 of the editor application window from FIG. 4.

FIG. 10 shows the Spline panel of the editor application window from FIG. 4.

FIG. 11 shows the Play panel of the editor application window from FIG. 4.

FIG. 12 is a block diagram of an exemplary host computer 1200 that performs the processing described herein.

FIG. 13 is a depiction of processing in the host computer to render a scene.

### DETAILED DESCRIPTION

A system constructed in accordance with the present invention produces a graphical presentation at a display of a host computer. The host computer executes a presentation application constructed in accordance with the present invention. The graphical presentation comprises a rendered audiovisual presentation at the display of the host computer according to a scene description. The presentation is updated in response to a digital music input. In updating the presentation and rendering it, the system evaluates trigger events in the scene description and matches the digital music events to trigger events of the scene description, then processes the action lists of the matched events to modify objects in the scene, thereby updating the scene description and the display presentation.

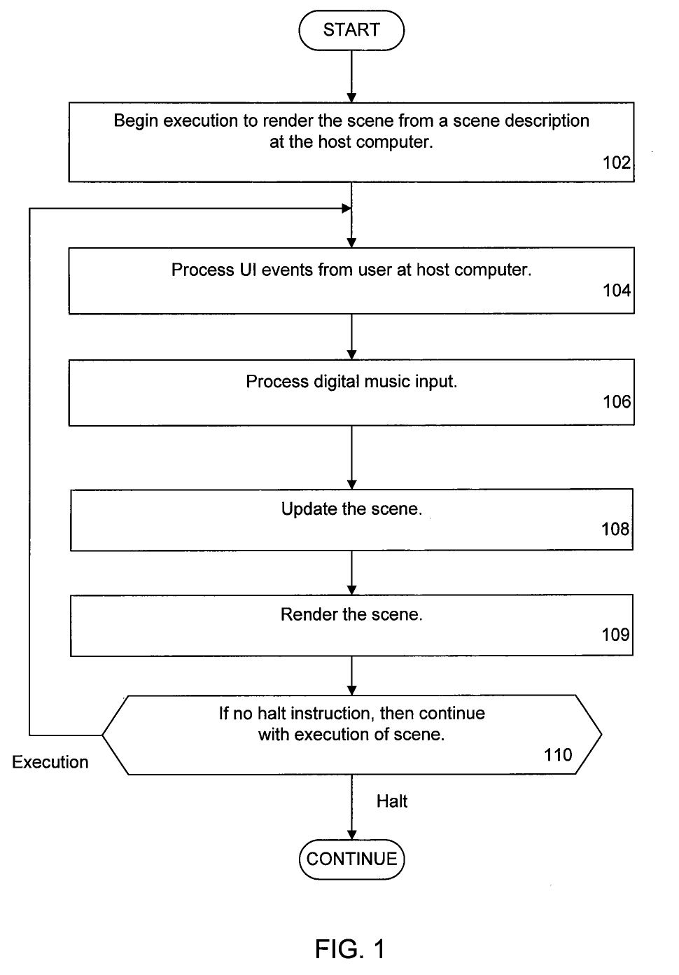

The processing is illustrated by the flow diagram of FIG. 1, which shows that a host computer system processes a scene as specified by a scene description, thereby beginning execution of the scene description. The scene processing comprises loading a scene description into working memory of the computer. This processing is represented by the flow diagram box numbered 102. The scene description defines one or more objects located in three-dimensional space of the rendered scene, as specified by the scene description. The system then monitors, or listens, for input from two sources at the host computer: user interface (UI) events from the user at the host computer (box 104) and digital music input received from a port of the host computer (box 106). The UI events may comprise events such as display mouse or computer keyboard activation by the user, or graphics table input, and the like. The musical instrument digital interface input can comprise signals received from a digital musical instrument connected to a suitable port of the host computer or from a stored digital music file.

The processed UI events from the user (at box 104 of FIG. 1) can comprise a variety of user input at the host computer that relate to the scene description and modify the rendered scene in accordance with the user input. Examples of UI events from the user include playback controls, by which the user can halt operation of the rendering and close the scene description. The user also can launch a scene description editor application, which provides a graphical user interface (GUI) through which the user can manipulate and change values in the scene description to be rendered, thereby effecting the scene that will rendered. The user-editable scene description parameters are described in more detail below.

The digital music input (at box 106 of FIG. 1) may comprise, for example, input received over an interface that is compatible with the MMA interface, wherein MMA is the MIDI (Musical Instrument Digital Interface) Manufacturer's Association protocol specification. Those skilled in the art will appreciate that a variety of musical instrument digital interfaces may be used, although the MIDI standard of the MMA is the most well-known and widely used for digital music representation. A wide variety of electronic musical instruments can be supported, including synthesizers that produce MIDI command streams for electronic piano, drum, guitar, and the like. Thus, the digital music input at box 106 can comprise a MIDI command stream that is delivered live (that is, in response to activation in real time) or delivered serially from a conventional MIDI file. Those skilled in the art will appreciate that a MIDI command stream can produce sounds that are triggered from a MIDI-enabled sound engine that receives MIDI commands as control inputs and that can produce corresponding sounds and musical notes. Such sounds and musical notes can be stored as *.wav, *.aiff, *.mp3 files, and the like. Other digitally encoded audio files can be used for input, as well. Such audio files can be easily played through digital media players. Moreover, musical interfaces such as the MMA MIDI interface can interact with graphical interfaces in real time as a digital instrument is played. For example, the illustrated embodiment utilizes graphics control through the DirectX interface, but OpenGL or any other graphics API could also be supported. Those skilled in the art will understand the integration details for such interaction, in view of the description herein. In the description herein, a MIDI input stream will be assumed for the digital music input, unless otherwise indicated. That is, references to “MIDI” input will be understood to include all varieties of digital music input described herein, unless otherwise indicated.

After the user UI events and MIDI port events are processed, the system updates the scene (box 108). Next, at box 109, the scene is rendered, meaning that applicable video and audio output is generated. Lastly, if no halt instruction or the like is received at box 110 execution is continued by returning to listening for, and processing, input from the user (box 104) and the musical instrument (box 106).

User Input

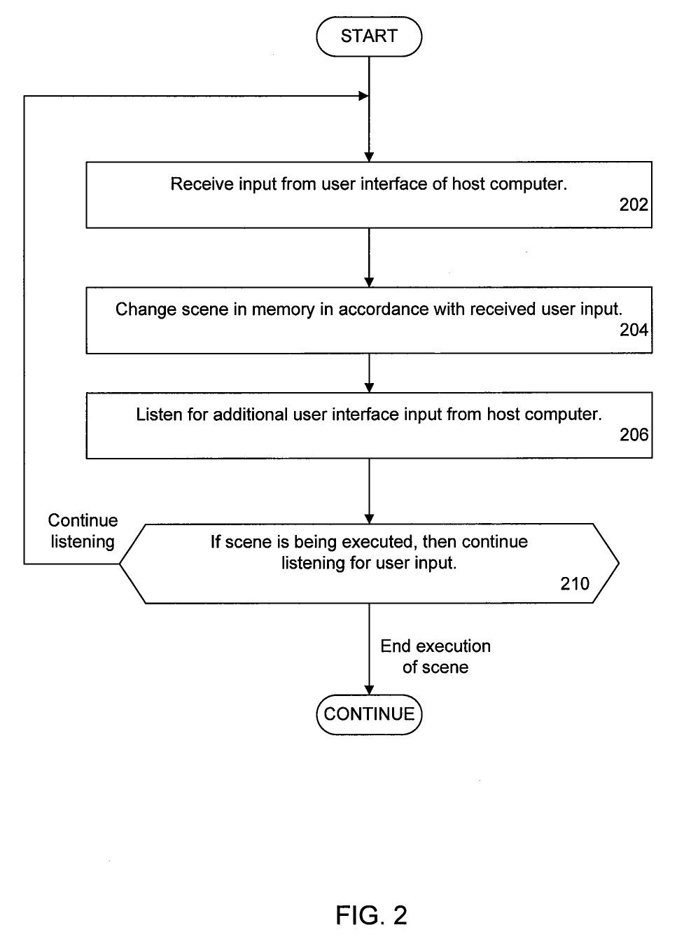

FIG. 2 shows additional details of processing the user input. First, at box 202, conventional computer operating system listening is performed, to await received input from the user interface. When user input is received that changes the scene description, such as object manipulation commands or changes in MIDI processing parameters, the scene description in memory that is being executed (rendered) is changed in accordance with that input. This is represented in FIG. 2 by the box 204. The system continues to listen for additional user events, as indicated at box 206. As noted above, execution of the scene description and listening for further user input continues, as indicated by the return from box 210 to box 202, until execution is halted by a user input.

Digital Music Input

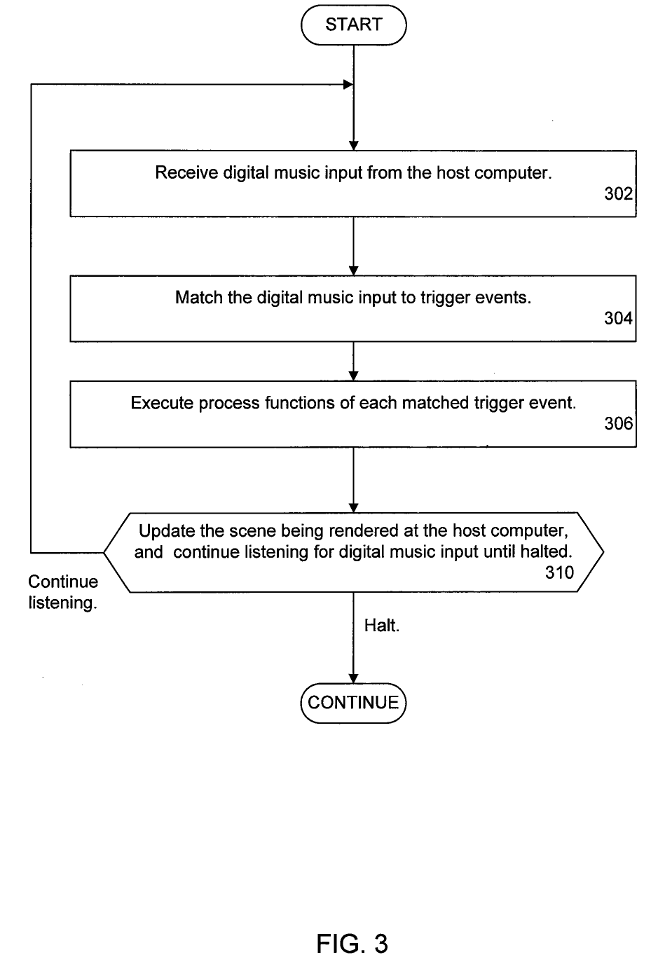

FIG. 3 shows additional details of processing the musical instrument digital interface (MIDI) input. First, at box 302, the host computer receives the MIDI input at a sound card through a MIDI port. The system then matches the digital music input to trigger events of the scene description, as indicated by box 304. The trigger events correspond to musical instrument actions that generate music note events, such as piano keys that are struck, guitar strings that are plucked, drum surfaces that are hit, and the like. The trigger events comprise MIDI commands such as the output from a synthesizer or other electronic music instrument. As noted above, a MIDI command stream can be played through a MIDI-enabled sound engine and can be stored as audio data in such common formats as Windows Media Player or Real Player or the like, including music files such as a *.WAV file or *.AIFF file or the like. Each trigger event is associated with process functions that are specified in the scene description. At box 306, the process functions are executed, thereby producing changes to the defined objects in the rendered scene. As noted previously, the scene description is updated per the digital music events and process functions, and the updated scene is rendered, while digital music input listening continues. This processing is indicated by box 310.

A variety of actions associated with the process functions may be carried out. For example, the actions may specify collisions between two or more objects of the scene description, and can include explosion of one or more objects of the scene description, or other movements of the objects in the scene description. The actions can be specified by user input so as to permit changes in speed, size, movement, color, and behavior of the scene objects.

Scene Description Data File

In the illustrated embodiment, the scene description can be recorded in a data file stored in a scene description format recognized by the playback (rendering) application of the system. One such scene description format is the “MIDI Paint Box” format (file extension of “.mpb”) by Starr Laboratories, Inc., the assignee of the present invention. Additional formats can be imported into the rendering application tool described herein, including 3D description formats such as those of “3D Studio Max” (*.3DS) from Autodesk, Inc. of San Rafael, Calif. USA and “X” graphics format files (*.X) of the DirectX 3D format supported by the DirectX API of Microsoft Corporation. Those skilled in the art will know of additional formats for 3D scene descriptions. The recorded scene description can be stored, for example, and loaded from auxiliary storage of the host computer. The scene description can be read from or obtained from a variety of data repositories, including memory of the host computer and external media such as disc storage, flash memory, network accessible storage, and the like.

As noted above, is not necessary that the digital music input must be received directly (live) from a musical instrument connected to the host computer. Similarly to the scene description, the digital music input can be received as a data file in a digital music file format, such as MIDI file or SMF file format. Thus, the digital music input format can be in accordance with the MIDI format of the MMA, referred to above, or can be implemented according to a different data format.

Editor Application

The illustrated embodiment includes a scene description editor application, which provides a graphical user interface (GUI) through which a user can specify the scene description, edit existing scene descriptions, and control rendering and playback of the scene description that is loaded in the host computer. In the present discussion, the editor application will be referred to as the MidiPaintBox.

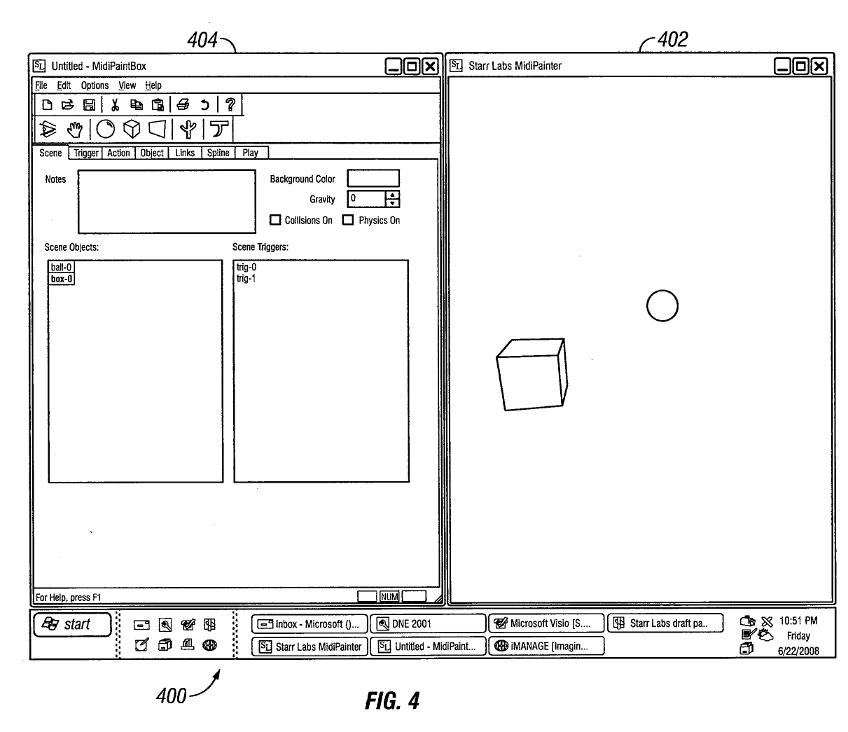

FIG. 4 shows a screen shot 400 of a host computer display with a playback window 402 showing a rendered scene description and an editor window 404 of the scene description editor application. The playback window 402 is shown adjacent to, and the same size as, the editor window 404, but it should be understood that the two windows are separately configurable and could be sized and placed as desired on the display of the host computer or in a dual display system such as commonly provided for by operating systems such as Windows by Microsoft Corporation and Apple Inc. of Cupertino, Calif. USA. The playback window 402, titled “Starr Labs MidiPainter”, shows a box and a ball in the scene area within the window. It should be understood that other objects and fewer or greater numbers of objects could be specified for the scene. The playback application and window 402 will also be referred to herein as the MidiPainter window. The editor window 404 shows tabs with the various scene characteristics and scene elements that can be defined by the user. These tabs include Scene, Trigger, Action, Object, Links, Spline, and Play. The editor application provides a GUI with which the user can define a scene and its associated parameters, and can save the defined scene as a data file. The saved data file can then be played (executed) such that the scene is rendered and displayed in the playback window 402. The editor window 404 will also be referred to herein as the MidiPaintBox window.

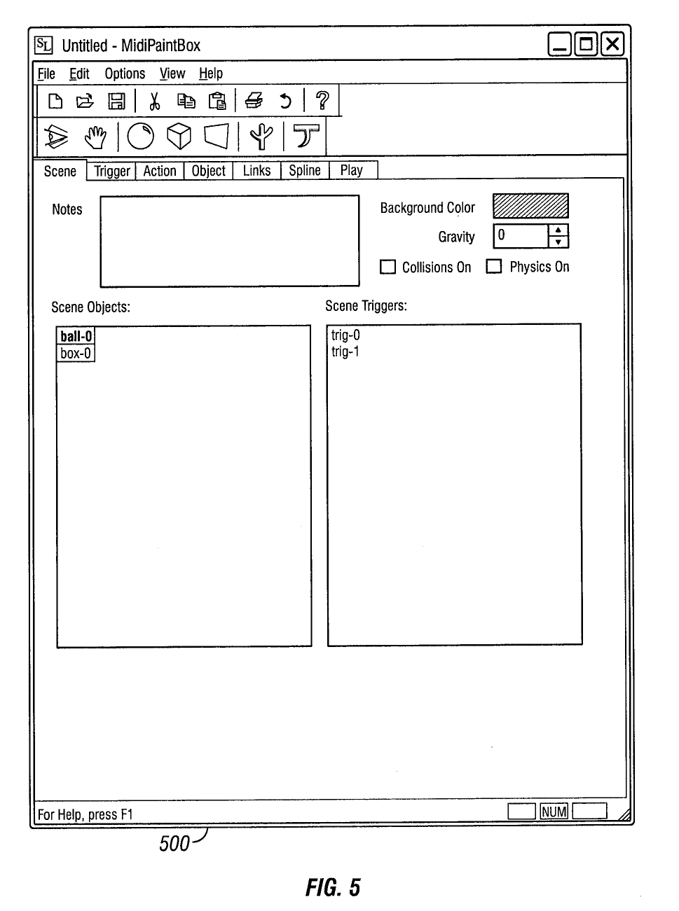

FIG. 5 is a detail view of the Scene tab panel of the editor application window 404 from FIG. 4. The FIG. 5 window 500 shows that the Scene panel includes a list of scene objects that have been defined by the user and includes a list of scene triggers that have been defined by the user. A menu bar above the objects list can be used to conveniently specify options such as new box and ball objects, imported objects, camera angles, lighting angles, splines, triggers, and the like. When the editor application 404 is launched with no specified scene description file, the scene is empty and therefore the accompanying playback window 402 is empty. The editor window 500 provides a convenient, graphical means of adding objects and other elements to the scene 402. It should be understood that, alternatively, an existing scene description can be loaded and edited or simply rendered. A single scene description can be loaded and rendered at any one time by the video processing of the host computer.

The editor window Scene panel 500 shows objects and elements of the scene description. Scene objects are listed in the left frame, and scene triggers are listed in the right frame. A user may add objects and specify their characteristics and parameters through the tool bar in FIG. 5, as described more fully below. FIG. 5 shows that the user also can specify background color of the scene as well as gravity effects, collisions, and movement (physics engine).

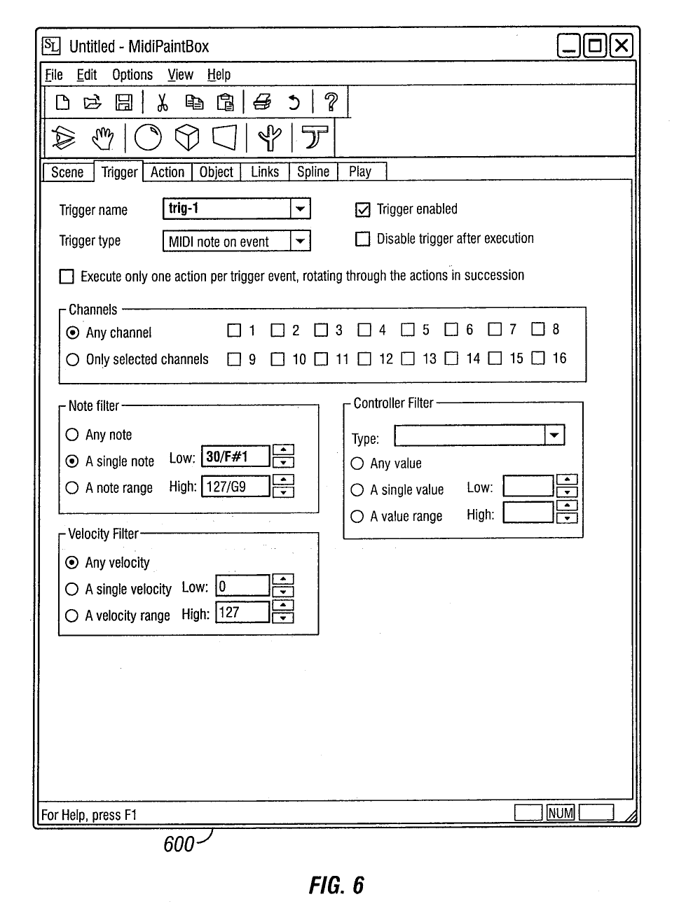

FIG. 6 shows details of the Trigger panel 600 of the editor application. The trigger events cause performance of actions that result in the actual translation of MIDI events into scene actions that alter the scene. The editor application Trigger panel provides a means for the user to add a trigger to the scene description by clicking the “T” icon on the toolbar button next to the cactus button. When the T icon is clicked, a new trigger will appear in the trigger list on the Scene panel (FIG. 5). Double-clicking in the trigger list in the Scene panel will select the clicked trigger and will automatically switch the application editor to the Trigger panel to display a detailed description of the trigger. As many triggers as desired can be added to the scene description, up to the limits of system resources.

Triggers can be associated with channels of MIDI input. The Trigger panel can be used to set a note filter and to set a velocity filter. The note filter processing comprises processing that responds to note number and channel, note range, musical scale and chordal tonalities, and/or note density of the updated scene description from what is otherwise specified by the musical instrument digital interface input. The velocity filter processes notes of the musical instrument digital interface input so as to adjust the note velocity from what is otherwise specified by the musical instrument digital interface input.

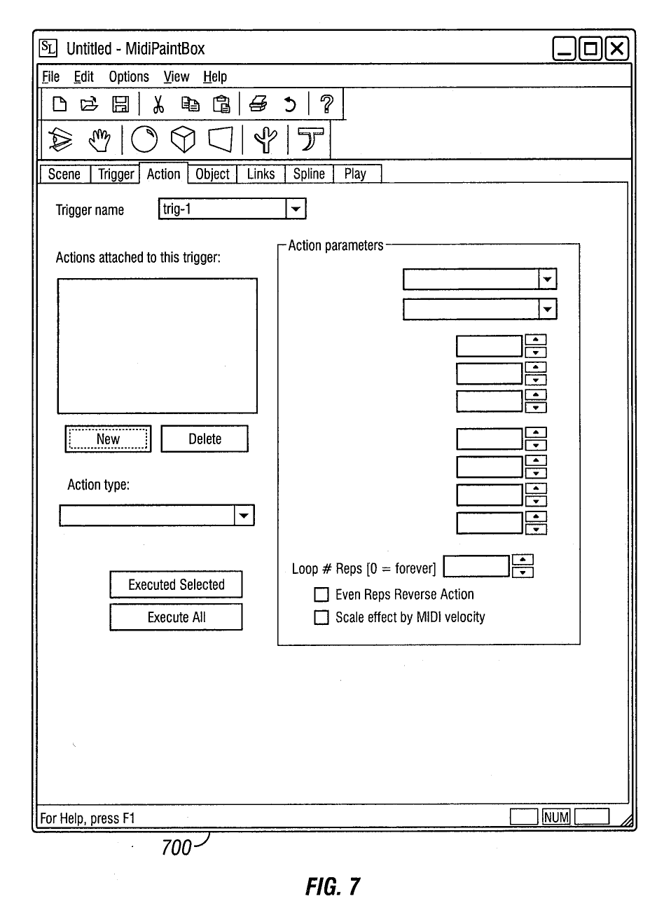

FIG. 7 shows the Action panel 700 of the editor application. Actions are created using the Action panel and are associated with a corresponding Trigger event. That is, a trigger event couples a MIDI event to a set of desired actions involving the scene description. Thus, each Trigger is associated with a set of one or more actions, which are initiated by a trigger event. A trigger event is selected from the drop-down box with Trigger name at the Action panel. The selected trigger is the trigger event to which the action will be specified and added by the user. When an action is initiated with the “New” button, the action will appear in the Action list in the window beneath the Trigger name drop-down box. In this way, additional actions can be added, as desired. As many actions as desired can be added to each trigger event in the scene description, up to the limits of system resources. For example, one type of trigger is an object collision, and a collision between two objects may therefore serve as a trigger event for an action. In this way, the events in a scene can be given somewhat autonomous behavior, as movement is initiated by collisions during the scene rendering.

The musical instrument digital interface input can be compatible with the MIDI interface specified by the MIDI (Musical Instrument Digital Interface) Manufacturer's Association (MMA) protocol specification. The illustrated embodiment operates in accordance with the MMA MIDI standard and therefore MIDI commands, such as Note-On, Note-Off, and ContinuousControl change, are used to initiate actions pursuant to the Trigger events, to provide the various graphic behaviors and transformations to the scene objects.

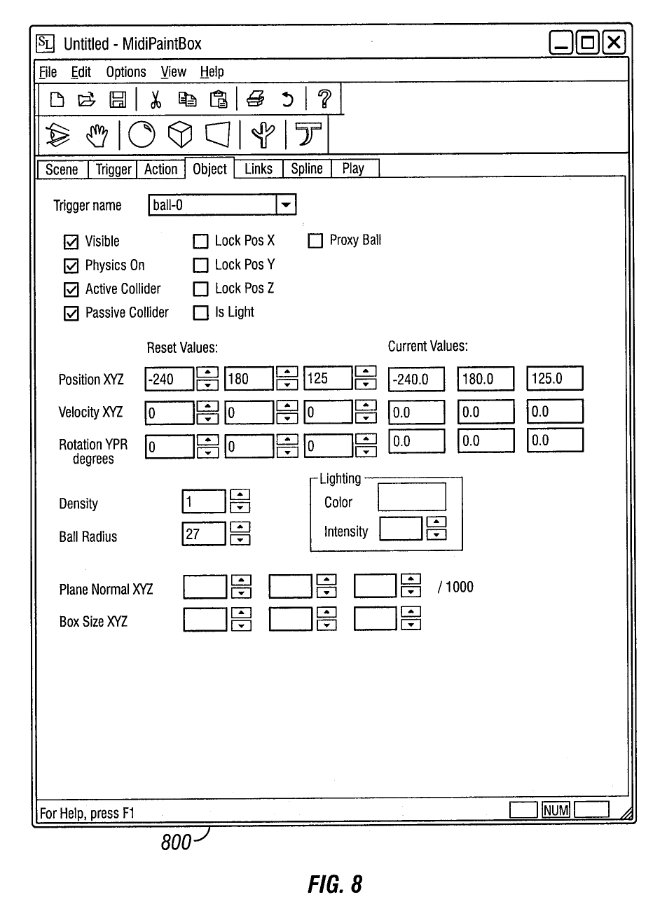

FIG. 8 shows the Object panel 800 of the editor application. The illustrated Object panel 800 supports adding five types of objects to the scene, including a ball, box, plane, 3DS description files, and “X” graphics format files. Other implementations may include additional types of objects. The toolbar illustrated in the editor window (FIGS. 5-8) includes a button for each of the simple objects (ball, box, and plane). Clicking on one of these three buttons will add the corresponding object to the scene, in both the playback window 402 and the object list on the Scene panel 500. The other two types of objects (3DS and X file) are loaded from data files. The toolbar button with the cactus icon is used to load both these types of objects from data files. Additional 3D graphics file formats can be supported by this selection. Clicking on the cactus button will cause a dialog box to appear that permits the user to choose a scene description data file or local or imported graphics file from the available file system for loading. In the illustrated embodiment, the loaded scene description files comprise *.mpb files that are loaded from the Scene menu. The loaded scene description will result in the scene appearing in the playback scene window 402. Objects that are added to the scene are initially given a default position and size based on a default (or user-specified) camera position and distance. Once in the scene, objects can be manipulated, moved, and edited through the edit application. For example, objects can be texture mapped with image data such as a JPEG file or other type of graphics file or texture data. Objects are assigned object names in the scene description, such as “ball-0” and “box-1”, though the editor application can be used to rename the objects. All objects in the scene must have a unique name identifier. FIG. 8 shows exemplary object parameters that can be set by the user. Reset values are values to which an object is returned after particular actions, such as explosions or collisions.

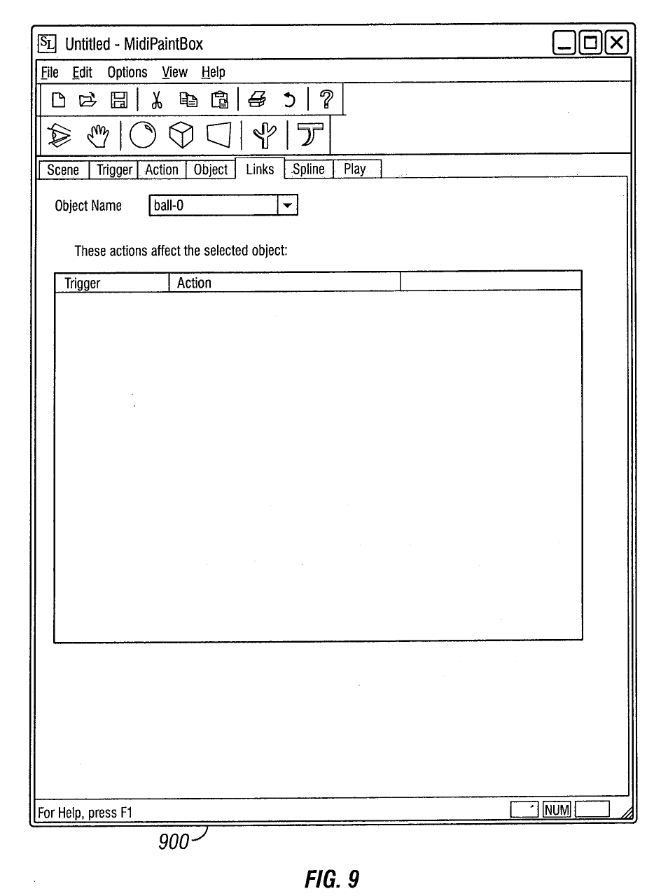

FIG. 9 shows the Links panel 900 of the editor application. The links page shows the subset of all trigger event actions contained in the scene description that affect a scene object. Each action is listed as well as the object that it affects. Thus, the links page can be used to quickly determine which actions affect a particular object. The links page is an alternate view to that of the action page, which shows the complete details of an action, but only displays the actions assigned to one trigger at a time.

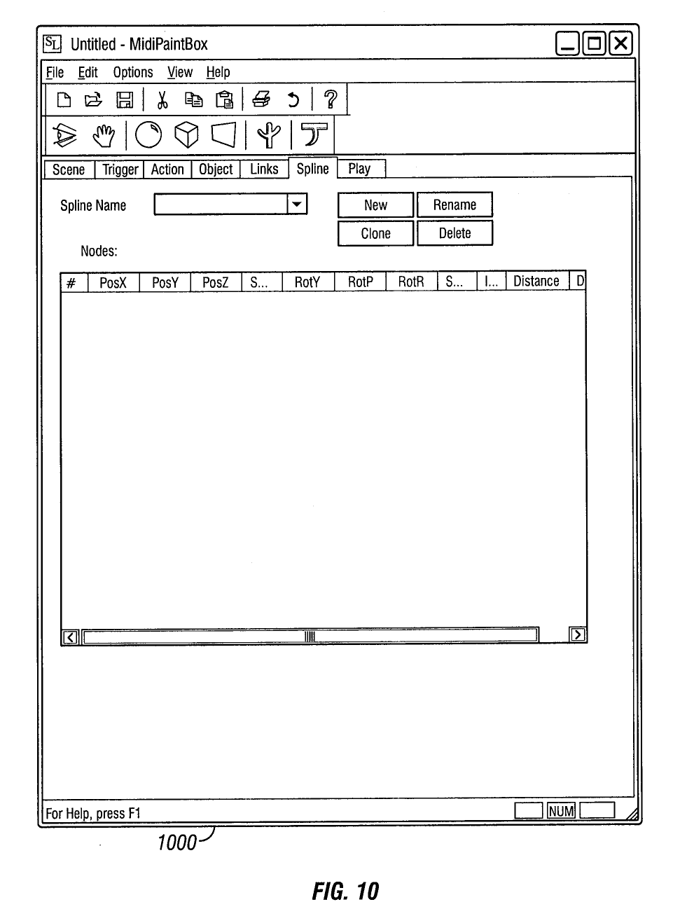

FIG. 10 shows the Spline panel 1000 of the editor application. The Spline panel permits a user to specify one or more spline nodes for an animation path in the scene description. Those skilled in the art will appreciate that the spline nodes will define a motion path through the scene that will be followed by an object. A new spline can be created by clicking on the “New” button of the Spline panel 1000. The node list box displays the nodes that the user has defined to make up the spline. A node is inserted by a right-click in the node list and selecting “Add” or “Insert” from the context menu. The Add command will insert a node at the end of the list, while the Insert command inserts a node in the position immediately before the node under the cursor. After a node has been inserted, its position and other parameters can be edited from the Spline panel by double-clicking in the node list.

Spline nodes are automatically given an initial position in the scene description based on the camera position, just as with regular scene objects. The initial position can be conveniently modified in a graphical interface by clicking the node on the display and dragging it with the computer mouse. The spline currently being edited appears in the playback window 402 as a segmented white line punctuated by balls. The balls are the spline nodes and indicate the actual positions in the scene that will be occupied by the object as it travels the spline path. When a spline motion is rendered the indexing balls are hidden from view. An object may also be positioned anywhere along the length of a spline rather than placing it at the aforementioned spline generation nodes.

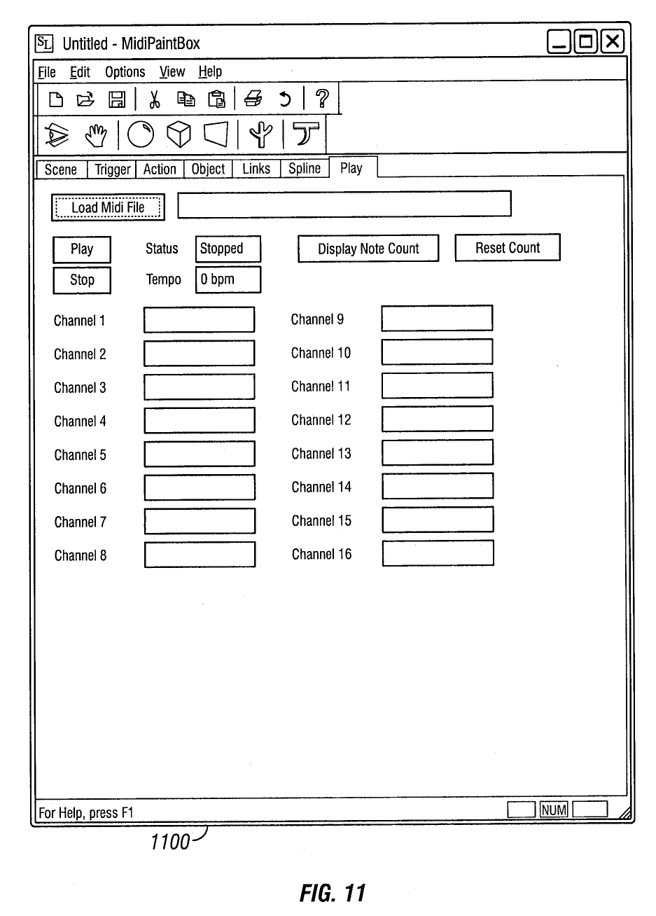

FIG. 11 shows the Play panel 1100 of the editor application. FIG. 11 shows that a user can specify a conventional MIDI file to be loaded and rendered, and can control execution or playback of the scene description. Options are provided for play and stop of the execution, and data windows are provided for monitoring status, tempo, and the data received from the MIDI input channels.

The illustrated embodiment provides an environment in which a digital music data stream interfaces with a Graphics API or function library, allowing 3D video graphics objects to be manipulated in real-time by a digital musical instrument, such as a MIDI -capable instrument, or a music playback file (e.g. *.WAV or *.AIFF). In this way, the described technique receives a musical instrument input stream and uses it to provide the kinetic on-screen activity for a 3D scene description, such that when the musical input stream stops, the scene activity on the display screen stops. Autonomous moving environments can be created that are similar to many video games that dictate the action and force the user's responses for navigation, avoidance, and targeting purposes.

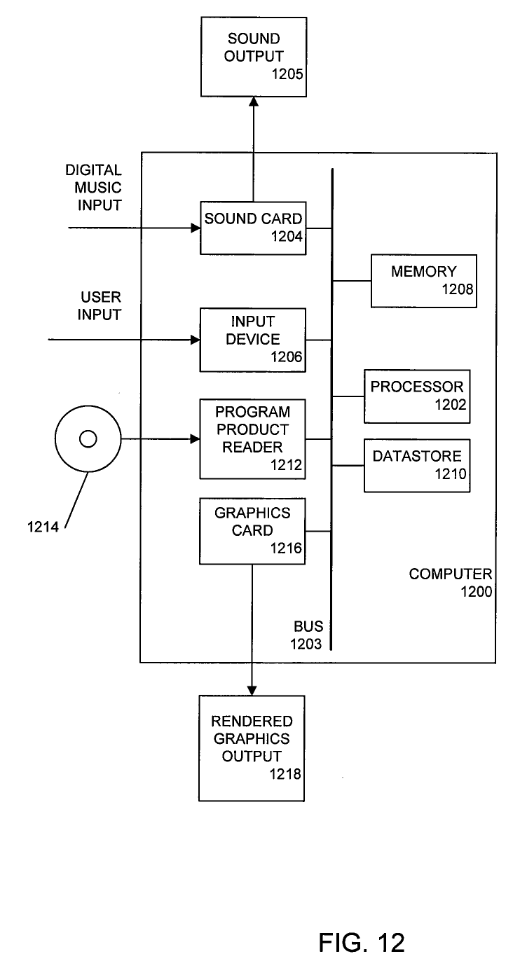

FIG. 12 is a block diagram of an exemplary host computer 1200 that performs the processing described herein. The computer includes a processor 1202, such as a general purpose computer chip and ancillary components, as provided in conventional personal computers, workstations, and the like that are generally available. Through the processor 1202, the computer executes program instructions to carry out the operations described herein. The processor communicates with other components of the computer over a system bus 1203 for data exchange and operations. The processor can operate with a sound card 1204 that processes digital music data, such as a digital music input data stream received from a digital music input device including a music synthesizer and the like, and can produce audio (sound) output 1205.

The processor 1202 also responds to input devices 1206 that receive user input, including such input devices as a computer keyboard, mouse, and other similar devices. The computer includes memory 1208, typically provided as volatile (dynamic) memory for storing program instructions, operating data, and so forth. The datastore 1210 is typically non-volatile memory, such as data disks or disk arrays. The computer can also include a program product reader 1212 that receives externally accessible media 1214 such as flash drives and optical media discs, and the like. Such media 1214 can include program instructions, comprising program products, that can be read by the reader 1212 and executed by the processor 1202 to provide the operation described herein. The processor uses a graphics or video card 1216 to visually render the objects in a scene description according to the digital music input received through the sound card 1204. The visually rendered graphics output can be viewed at a display device 1218, such as visual display devices and the like. The sound output 1205 and rendered graphics output 1218 together comprise the rendered scene output, providing a multimedia presentation.

The system 1200 receives digital music in the form of a MIDI data stream that is interpreted by the processor 1202 and is sent as instructions to a sound card to play effects and musical notes, which may be stored as *.WAV files or in other suitable formats, or to be synthesized directly by the music application software. The same MIDI stream, which may be delivered from a live performance or from a stored MIDI file, is also processed by the software described herein and is delivered to the computer's video processor for output to the video display monitor as the rendered scene. It should be understood that the computer sound card 1204 could be replaced by a dedicated hardware music synthesizer.

The scene description described above can be stored as a data file in the computer memory 1208 or can be stored as a data file in the datastore 1210. As noted above, the datastore can comprise internal storage such as a hard disk, or can comprise external or auxiliary storage, such as removable disk media or flash drives or network connected datastore devices. The processor 1202 can execute instructions to provide a graphics engine capability for rendering the scene description, or can provide such a graphics rendering engine in conjunction with processing by the graphics card 1216.

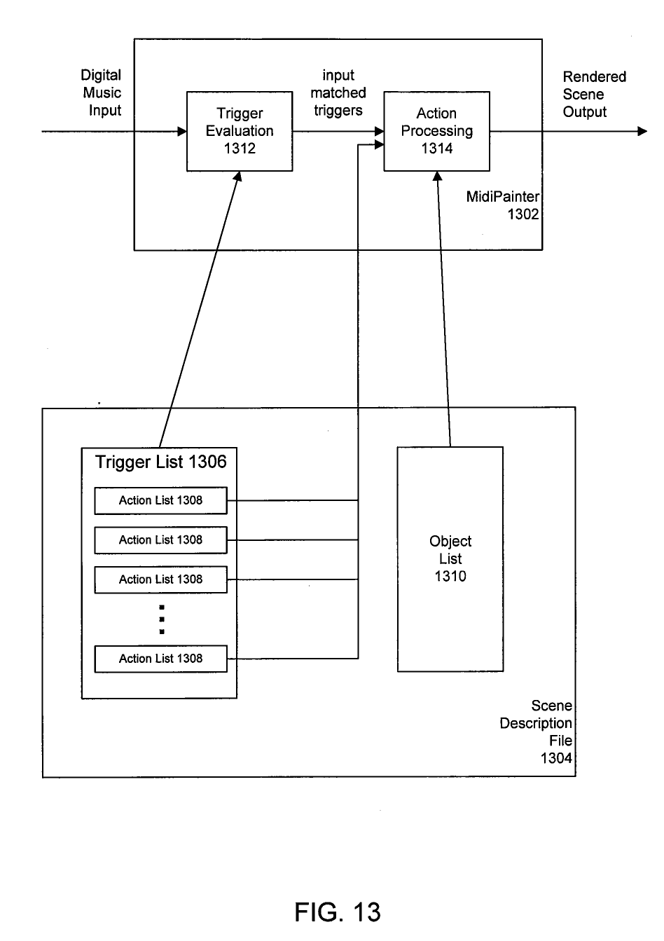

FIG. 13 is a depiction of processing in the host computer 1200. FIG. 13 shows the MidiPainter module 1302 of the host computer, which is responsible for rendering the scene description file 1304 that is being processed in accordance with the digital music input. As described above, the scene description file is created and edited using the MidiPaintBox application, which is installed at the computer 1200. The scene description file 1304 is shown in FIG. 13 as containing data comprising the trigger list 1306, action list items 1308, and an object list 1310. The scene description file is received by the MidiPainter module/application, which evaluates the trigger list based on digital music input that is matched to the trigger list for the scene. After the triggers are matched with the incoming digital music input, the actions that constitute the action list of each matched trigger are executed, thereby changing the scene display. The action list 1308 items are shown in FIG. 13 contained within the trigger list 1306 to indicate that a list of actions is assigned to each trigger.

In this way, the scene description file 1304 provides a means of encapsulated scene description data in a single, unitary data file that can be recognized by the operating system of the host computer so that the MidiPainter application can receive all the data necessary for rendering a scene and can automatically perform rendering in response to digital music input, in accordance with the scene description data. Thus, a user can work through a convenient user interface for editing a scene description using the MidiPaintBox module, and the MidiPainter module can process the self-contained scene description file and automatically utilize system resources and perform internal data transfers necessary to render the scene in a fashion that is transparent to the user. That is, users need not concern themselves with linking various data files and specifying system resources to be used for rendering, and edits to the scene are easily accomplished through the MidiPaintBox module and stored in the scene description data file for processing by the MidiPainter module.

The present invention has been described above in terms of a presently preferred embodiment so that an understanding of the present invention can be conveyed. There are, however, many configurations for graphics-musical interface interaction not specifically described herein but with which the present invention is applicable. The present invention should therefore not be seen as limited to the particular embodiments described herein, but rather, it should be understood that the present invention has wide applicability with respect to graphics-musical interface interaction systems generally. All modifications, variations, or equivalent arrangements and implementations that are within the scope of the attached claims should therefore be considered within the scope of the invention.

We claim:

1. A method of producing a graphical presentation at a display of a host computer, the method comprising:
rendering a scene according to a scene description at the display of the host computer;
receiving a musical instrument digital interface input;
matching the musical instrument digital interface input to trigger events of the scene description;
executing actions of each matched trigger event in accordance with action processes of the scene description;
rendering the updated scene description, thereby updating the scene description with respect to objects depicted in the scene on which the actions are executed;
wherein the scene description comprises a data file containing data that specifies the trigger events, action processes, and scene objects.

2. The method as defined in claim 1, further including:
receiving user input at the host computer;
modifying the rendered scene in accordance with the user input relating to the scene description.

3. The method as defined in claim 1, wherein the scene description data file defines one or more objects located in three-dimensional space of the rendered scene.

4. The method as defined in claim 3, wherein executing the action processes on the scene objects produces changes to the rendered scene.

5. The method as defined in claim 4, wherein the action processes comprise movement of the scene objects in accordance with the trigger events.

6. The method as defined in claim 5, wherein the actions include collisions between two or more objects of the scene description in accordance with user specified parameters.

7. The method as defined in claim 5, wherein the actions include explosion of at least one object of the scene description in accordance with user specified parameters.

8. The method as defined in claim 5, wherein the actions include movement of the objects in the scene description in accordance with user specified parameters.

9. The method as defined in claim 1, wherein the scene description is loaded from auxiliary storage of the host computer.

10. The method as defined in claim 1, wherein the scene description is read from memory of the host computer.

11. The method as defined in claim 1, wherein the scene description is obtained from a data file stored in a scene description format.

12. The method as defined in claim 1, wherein the musical instrument digital interface input is received from a data file in a musical instrument digital interface file format.

13. The method as defined in claim 1, further including receiving the scene description from a scene description editor application at the host computer such that the received scene description includes one or more user-specified parameters.

14. The method as defined in claim 13, wherein the received scene description defines one or more scene objects located in three-dimensional space of the rendered scene.

15. The method as defined in claim 14, wherein the received scene description is stored as a data file in a scene description format.

16. The method as defined in claim 14, wherein the received scene description specifies the scene trigger events.

17. The method as defined in claim 16, wherein the received scene description further includes at least one note filter that processes notes of the musical instrument digital interface input.

18. The method as defined in claim 17, wherein the note filter processing comprises processing that adjusts note density of the updated scene description from what is otherwise specified by the musical instrument digital interface input.

19. The method as defined in claim 17, wherein the note filter processing comprises processing that adjusts note range of the updated scene description from what is otherwise specified by the musical instrument digital interface input.

20. The method as defined in claim 16, wherein the received scene description further includes at least one velocity filter that processes notes of the musical instrument digital interface input so as to adjust the note velocity from what is otherwise specified by the musical instrument digital interface input.

21. The method as defined in claim 14, wherein the received scene description permits user specification of the process functions of the trigger events.

22. The method as defined in claim 14, wherein the received scene description specifies links between two or more trigger events of the scene description.

23. The method as defined in claim 14, wherein the received scene description specifies one or more spline nodes for an animation path in the scene description.

24. The method as defined in claim 14, wherein the received scene description specifies scene rendering controls and one or more input channels specified for the musical instrument digital interface.

25. The method as defined in claim 1, wherein the musical instrument digital interface comprises an interface that is MMA-compatible, wherein the MMA interface is a MIDI (Musical Instrument Digital Interface) Manufacturer's Association protocol specification.

26. A system for producing a graphical presentation at a display of a host computer, the system comprising:
a graphics rendering engine of the host computer that renders a scene from a scene description at the display of the host computer;
a presentation processor of the host computer that receives a digital music input and matches the digital music input to trigger events of the scene description, and that executes actions of each matched trigger event in accordance with action processes of the scene description, thereby updating the scene description with respect to objects depicted in the scene on which the actions are executed, wherein the scene description comprises a data file containing data that specifies the trigger events, action processes, and scene objects.

27. The system as defined in claim 26, wherein the presentation processor receives user input at the host computer and modifies the rendered scene in accordance with the user input relating to the scene description.

28. The system as defined in claim 26, wherein the scene description defines one or more objects located in three-dimensional space of the rendered scene.

29. The system as defined in claim 28, wherein the presentation processor controls execution of the action processes on the scene objects to produce changes to the rendered scene.

30. The system as defined in claim 29, wherein the action processes comprise movement of the scene objects in accordance with the trigger events.

31. The system as defined in claim 30, wherein the actions include collisions between two or more objects of the scene description in accordance with user specified parameters.

32. The system as defined in claim 30, wherein the actions include explosion of at least one object of the scene description in accordance with user specified parameters.

33. The system as defined in claim 30, wherein the actions include movement of the objects in the scene description in accordance with user specified parameters.

34. The system as defined in claim 26, wherein the scene description is loaded from auxiliary storage of the host computer.

35. The system as defined in claim 26, wherein the scene description is read from memory of the host computer.

36. The system as defined in claim 26, wherein the scene description is obtained from a data file stored in a scene description format.

37. The system as defined in claim 26, wherein the musical instrument digital interface input is received from a data file in a musical instrument digital interface file format.

38. The system as defined in claim 26, wherein the system further includes a scene description editor application, and the presentation processor receives the scene description from the scene description editor application at the host computer.

39. The system as defined in claim 38, wherein the scene description editor application provides a graphical user interface through which one or more scene objects located in three-dimensional space of the rendered scene can be defined, comprising the scene description.

40. The system as defined in claim 39, wherein the scene description editor application stores the scene description as a data file in a scene description format.

41. The system as defined in claim 39, wherein the graphical user interface of the scene description editor application permits user specification of the scene trigger events.

42. The system as defined in claim 41, wherein the received scene description further includes at least one note filter that processes notes of the musical instrument digital interface input.

43. The system as defined in claim 42, wherein the note filter processing comprises processing that adjusts note density of the updated scene description from what is otherwise specified by the musical instrument digital interface input.

44. The system as defined in claim 42, wherein the note filter processing comprises processing that adjusts note range of the updated scene description from what is otherwise specified by the musical instrument digital interface input.

45. The system as defined in claim 41, wherein the received scene description further includes at least one velocity filter that processes notes of the musical instrument digital interface input so as to adjust the note velocity from what is otherwise specified by the musical instrument digital interface input.

46. The system as defined in claim 39, wherein the graphical user interface of the scene description editor application permits user specification of the process functions of the trigger events.

47. The system as defined in claim 39, wherein the graphical user interface of the scene description editor application permits user specification of links between two or more trigger events of the scene description.

48. The system as defined in claim 39, wherein the graphical user interface of the scene description editor application permits user specification of one or more spline nodes for an animation path in the scene description.

49. The system as defined in claim 39, wherein the graphical user interface of the scene description editor application permits user control of scene rendering and specification of one or more input channels for the musical instrument digital interface.

50. The system as defined in claim 26, wherein the digital music input is received through an interface that is MMA-compatible, wherein the MMA interface is a MIDI (Musical Instrument Digital Interface) Manufacturer's Association protocol specification.

51. A scene description editor application that executes at a host computer, the scene description editor application providing a graphical user interface through which a user can create a scene description that defines one or more scene objects located in three-dimensional space of a scene to be rendered, wherein the scene description produces a graphical presentation at a display of the host computer when rendered such that the graphical presentation comprises a scene rendered in accordance with a scene description and in response to received digital music input such that the input is matched to trigger events of the scene description and action processes of each matched trigger event are executed, thereby updating the scene description with respect to objects depicted in the scene on which the actions are executed, wherein the scene description comprises a data file containing data that specifies the trigger events, action processes, and scene objects.

52. The editor application as defined in claim 51, wherein the scene description editor application stores the scene description as a data file in a scene description format.

53. The editor application as defined in claim 51, wherein the graphical user interface of the scene description editor application permits user specification of the scene trigger events.

54. The editor application as defined in claim 51, wherein the received scene description further includes at least one note filter that processes notes of the musical instrument digital interface input.

55. The editor application as defined in claim 54, wherein the note filter processing comprises processing that adjusts note density of the updated scene description from what is otherwise specified by the musical instrument digital interface input.

56. The editor application as defined in claim 55, wherein the note filter processing comprises processing that adjusts note range of the updated scene description from what is otherwise specified by the musical instrument digital interface input.

57. The editor application as defined in claim 54, wherein the received scene description further includes at least one velocity filter that processes notes of the musical instrument digital interface input so as to adjust the note velocity from what is otherwise specified by the musical instrument digital interface input.

58. The editor application as defined in claim 51, wherein the graphical user interface of the scene description editor application permits user specification of the process functions of the trigger events.

59. The editor application as defined in claim 51, wherein the graphical user interface of the scene description editor application permits user specification of links between two or more trigger events of the scene description.

60. The editor application as defined in claim 51, wherein the graphical user interface of the scene description editor application permits user specification of one or more spline nodes for an animation path in the scene description.

61. The editor application as defined in claim 51, wherein the graphical user interface of the scene description editor application permits user control of scene rendering and specification of one or more input channels for the musical instrument digital interface.

62. The editor application as defined in claim 51, wherein the digital music input is received through an interface that is MMA-compatible, wherein the MMA interface is a MIDI (Musical Instrument Digital Interface) Manufacturer's Association protocol specification.
